(19) United States
(12) Patent Application Publication
(10) Pub. No.: US 2025/0277395 A1
(43) Pub. Date: Sep. 4, 2025

(54) MOTOR VEHICLE LOCK

(71) Applicant: Brose Schliesssysteme GmbH & Co. Kommanditgesellschaft, Wuppertal (DE)

(72) Inventor: Arkadi Bogorats, Haan (DE)

(21) Appl. No.: 18/267,627

(22) PCT Filed: Dec. 6, 2021
(86) PCT No.: PCT/EP2021/084311

§ 371 Date: Nov. 10, 2023

(30) Foreign Application Priority Data
Dec. 15, 2020 (DE) 10 2020 133 537.7

(51) Int. Cl. E05B 85/26; E05B 77/42; E05B 81/04; E05B 85/24

(52) U.S. Cl. CPC E05B 85/26; E05B 77/42; E05B 81/04; E05B 85/243

(57) ABSTRACT

A lock with an intermediate lever that is configured to be brought into a basic position and a deflection position. The lock can include a movably mounted blocking part interacting with the intermediate lever. In the engagement position, the pawl locks the latch against pivoting in its opening direction, and, in the disengagement position, releases the latch into its opening direction. In the locking position, the blocking part can block the intermediate lever against pivoting in the deflection direction. In the release position, it releases the intermediate lever. The intermediate lever upon pivoting from its basic position into its deflection position brings the pawl into its disengagement position. The blocking part comprises a contour arrangement with a pressing contour, and during the movement of the blocking part, a force can be exerted by the blocking part resulting in a torque is being produced on the intermediate lever.

### CROSS-REFERENCE TO RELATED APPLICATIONS

This application is a national stage application under 35 U.S.C. 371 of International Patent Application Serial No. PCT/EP2021/084311, entitled “Motor Vehicle Lock,” filed Dec. 6, 2021, which claims priority from German Patent Application No. DE 10 2020 133 537.7, filed Dec. 15, 2020, the disclosure of which is incorporated herein by reference.

### FIELD OF THE TECHNOLOGY

Various embodiments relate to a motor vehicle lock having a lock latch and a pawl arrangement.

### BACKGROUND

The known motor vehicle lock (EP 2 492 423 B1) has a lock latch which is pivotable about a geometrical lock latch pivot axis and interacts in a customary manner with a locking part, in particular striker. To block the lock latch in its respective locking position, the motor vehicle lock has a pawl arrangement which is assembled from a pawl, an intermediate lever and a lever-shaped blocking part, referred to below as a blocking lever. The pawl, which interacts directly with the lock latch, is mounted on the intermediate lever so as to be pivotable about a geometrical pawl pivot axis and thus follows pivoting movements of the intermediate lever about the geometrical intermediate lever pivot axis thereof. The blocking lever is pivotable here about a geometrical blocking part pivot axis between a blocking position and a release position. In the blocking position, the blocking lever blocks the intermediate lever, which is in its basic position, against pivoting in the deflection direction thereof. In the release position, the intermediate lever is released from the blocking part. The forces which act on the lock latch from the locking part and are attributed primarily to the door seal counter pressure are transmitted by the lock latch, which is in its locking position, via the engaged pawl to the intermediate lever such that the latter, when it is released from the blocking part, can pivot in the deflection direction thereof. The lock latch thereby presses the pawl with simultaneous pivoting of the intermediate lever in the deflection direction thereof.

This mechanism functions highly reliably when the lever mechanism is freely movable. However, in certain environmental conditions, for example at very low outside temperatures, jamming, for example due to icing, may occur, as a result of which pivoting of the intermediate lever in its deflection direction is made more difficult when the motor vehicle lock is intended to be opened.

### SUMMARY

Various embodiments can be based on the problem of optimizing the operational reliability of the motor vehicle lock in unfavorable environmental conditions, in particular at low outside temperatures.

The above problem is solved in the case of a motor vehicle lock according to various embodiments provided herein.

The motor vehicle lock under discussion can be assigned to any closure element of a motor vehicle. This includes tailgates, trunk lids, front hoods, in particular engine hoods, side doors or the like. These closure elements can be configured to be pivotable or in the manner of sliding doors.

Essentially, one consideration is to give the blocking part, which is configured in particular as a blocking lever, a further function in addition to its known blocking function. The further function consists in that the blocking part, as it moves in its release direction, can force the intermediate lever in the direction of the deflection position thereof. Should the intermediate lever then be jammed in its basic position because of unfavorable environmental conditions, the blocking part can exert an additional force on the intermediate lever in order to deflect it. Possible jamming of the intermediate lever is thereby reliably released, and the intermediate lever is “broken free”. Such a function is also referred to as an ice breaker function.

It should be particularly emphasized here that an in any case driven component of the pawl arrangement, namely the blocking part, is provided with an additional function, said icebreaker function, which is automatically carried out by a regular movement of the blocking part in its release direction. By this means, the operational reliability of the motor vehicle lock is significantly improved with simple measures.

In principle, according to various embodiments of the motor vehicle lock, if there is no jamming, for example due to icing or the like, the intermediate lever can, however, also be brought by itself or essentially by the forces which are exerted on it by the lock latch into is deflection position and the pawl can be disengaged. According to various embodiments, provision may also be made, however, that the pivoting of the intermediate lever is brought about by itself or essentially by the movement of the blocking part.

In detail, it is now proposed that the blocking part has a contour arrangement with a pressing contour, and in that during the, in particular motor-driven, movement of the blocking part in its release direction, a force, in particular compressive force, can be exerted by the blocking part via its pressing contour on the intermediate lever, owing to which a torque is produced on the intermediate lever about its intermediate lever pivot axis in the deflection direction thereof. It should be noted that the movement of the blocking part can not only be motor-driven but also, according to another embodiment, can be additionally or alternatively brought about manually, in particular via an actuating lever. Such an actuating lever is coupled, for example, to a door handle, in particular door inside handle or door outside handle, in order to bring about the movement of the blocking part.

According to various embodiments, the contour arrangement of the blocking part has a blocking contour via which said blocking function is brought about. The blocking contour therefore serves in the blocking position of the blocking part to block the intermediate lever, which is in the basic position, against pivoting in the deflection direction thereof about the geometrical intermediate lever pivot axis.

Some embodiments relate to a guide piece of the intermediate lever, for example a protrusion, in particular a cam, which can be guided along the pressing contour and/or along the blocking contour in order to ensure the transmission of force between the blocking part and the intermediate lever.

Some embodiments specify that the respective force, owing to which the torque is produced on the intermediate lever in the deflection direction thereof, can be exerted on the intermediate lever by the blocking part during the movement of the blocking part from the blocking position into the release position and/or from the release position into an end position. The end position is a position which also goes beyond the release position from the direction of the blocking position. It is therefore conceivable that the blocking part at the beginning of its movement, in particular pivoting movement, out of the blocking position still does not exert any force on the intermediate lever, but rather merely first of all releases the latter and only then exerts said force on the intermediate lever. Alternatively, however, a refinement is also conceivable in which, even from the beginning of moving out of the blocking position, a force is exerted on the intermediate lever by the blocking part.

Some embodiments relate to an optional guide contour which can likewise be part of the contour arrangement of the blocking part and via which the intermediate lever can be braked during the pivoting from its basic position into its deflection position. When the lock latch is greatly pretensioned in its opening direction, the intermediate lever, when the latter is released from the blocking part, may abruptly be shifted in the direction of its deflection position. This can lead to an undesirable production of noise which is avoided by said guide contour of the blocking part. Alternatively or additionally, a suitable pretensioning of the intermediate lever counter to its deflection direction can also prevent such an abrupt movement. Accordingly, a separate guide contour can also be dispensed with.

According to various embodiments, a closed guide slot is provided which forms the pressing contour and the blocking contour. A closed guide slot means that a contour is provided which is completely encircling on the inside and comprises the pressing contour and the blocking contour. In this way, the blocking part is particularly stable and, for example, even in the event of a crash, cannot be deformed in such a manner that it bends upward and inadvertently releases the intermediate lever. Additionally or alternatively, however, a stop part which is fixed with respect to the housing can also be provided, the stop part preventing an inadvertent bending upward of the blocking part, in particular of a portion of the blocking part comprising the blocking contour.

According various embodiments, the intermediate lever forms a toggle lever mechanism together with the pawl.

Various embodiments define profiles of the force action line of the contact force between the intermediate lever and the blocking part. Said force action line can run through the blocking part pivot axis. In principle, however, it can also run past the latter, such as in such a manner that owing to the forces transmitted to the intermediate lever on the lock latch side, a torque is always produced on the blocking part in the blocking direction thereof. In principle, however, the case is also conceivable that the force action line runs past on the other side of the blocking part pivot axis.

Various embodiments relate to a profile of the force action line of the contact force between the lock latch and the pawl. Said force action line can run through the pawl pivot axis. Also here, however, other profiles are in principle also conceivable.

Various embodiments provide arrangements of the pivot axes of the individual levers of the blocking mechanism of the motor vehicle lock, i.e. of the lock latch and the pawl arrangement. The pawl pivot axis can be, as already mentioned, arranged on the intermediate lever.

Various embodiments relate to possibilities of the pretensioning, in particular spring pretensioning, of the levers of the blocking mechanism.

According to various embodiments, a drive arrangement, in particular motorized drive arrangement with an electric drive motor, is provided to drive the blocking part. In this case, a blocking part drive shift can extend through a housing wall of the motor vehicle lock. This has the advantage that, whenever the housing wall forms a partition between a wet side and dry side of the motor vehicle lock, the passage of the drive train through the housing wall can be sealed in a simple manner.

Various embodiments provide a motor vehicle lock having a lock latch and a pawl arrangement, wherein the lock latch is pivotable into at least one locking position, in particular a main locking position and optionally a pre-locking position, in which it is in each case in holding engagement with a locking part, and into an open position, in which it releases the locking part, wherein the pawl arrangement has a pivotably mounted pawl which interacts with the lock latch and can be brought into an engagement position and a disengagement position, a pivotably mounted intermediate lever which interacts with the pawl and can be brought into a basic position and a deflection position, and a movably mounted blocking part interacting with the intermediate lever, in particular a pivotably mounted blocking lever, which can be brought into a locking position and a release position, wherein, in the engagement position, the pawl locks the locks latch, which is in the respective locking position, against pivoting in its opening direction, and, in the disengagement position, releases the lock latch into its opening direction, wherein, in the locking position, the blocking part blocks the intermediate lever, which is in the basic position, against pivoting in the deflection direction thereof, and, in the release position, releases the intermediate lever in the deflection direction thereof, wherein, in the basic position of the intermediate lever, the pawl is in its engagement position or is pivotable into its engagement position, and wherein the intermediate lever upon pivoting from its basic position into its deflection position brings the pawl into its disengagement position, wherein the blocking part has a contour arrangement with a pressing contour, and in that during the, in particular motor-driven, movement of the blocking part in its release direction, a force, in particular compressive force, can be exerted by the blocking part via its pressing contour on the intermediate lever, owing to which a torque is produced on the intermediate lever about its intermediate lever pivot axis in the deflection direction thereof.

In various embodiments, the contour arrangement of the blocking part has a blocking contour via which, in the blocking position, the intermediate lever, which is in the basic position, is blocked against pivoting in the deflection direction thereof, wherein the pressing contour and the blocking contour can be spaced apart from each other and in particular face each other.

In various embodiments, a guide piece of the intermediate lever can be guided along the pressing contour and/or along the blocking contour, wherein a common guide piece can be guided along the pressing contour and along the blocking contour.

In various embodiments, the respective force, owing to which the torque is produced on the intermediate lever in the deflection direction thereof, can be exerted on the intermediate lever by the blocking part during the, in particular motor-driven, movement of the blocking part from the blocking position into the release position and/or from the release position into an end position.

In various embodiments, the contour arrangement of the blocking part has a guide contour via which the intermediate lever, in particular a guide piece or the guide piece of the intermediate lever, can be braked during the pivoting from its basic position into its deflection position after the blocking part has passed from its blocking position into its release position, wherein the guide contour and the pressing contour can be spaced apart from each other and in particular face each other and/or the guide contour adjoins the blocking contour, or wherein the intermediate lever cannot be braked by the blocking part during the pivoting from its basic position into its deflection position after the blocking part has passed from its blocking position into its release position.

In various embodiments, the contour arrangement of the blocking part has a closed guide slot which forms the pressing contour and the blocking contour, in particular also the guide contour.

In various embodiments, the intermediate lever forms a toggle lever mechanism together with the pawl.

In various embodiments, when the intermediate lever is in the basic position and the blocking part is in the blocking position, the blocking part is in supporting engagement via a supporting surface, in particular via the blocking contour, with the intermediate lever, in particular via the guide piece, and the force action line of the contact force between the intermediate lever and the blocking part runs through the blocking part pivot axis.

In various embodiments, when the intermediate lever is in the basic position and the blocking part is in the blocking position, the blocking part is in supporting engagement via a supporting surface, in particular via the blocking contour, with the intermediate lever, in particular via the guide piece, and the force action line of the contact force between the intermediate lever and the blocking part runs past the blocking part pivot axis in such a manner that, owing to the forces transmitted to the intermediate lever, a torque is always produced on the blocking part in a direction opposite to the release direction.

In various embodiments, when the intermediate lever is in the basic position and the blocking part is in the blocking position, the blocking part is in supporting engagement via a supporting surface, in particular via the blocking contour, with the intermediate lever, in particular via the guide piece, and the force action line of the contact force between the intermediate lever and the blocking part runs past the blocking part pivot axis in such a manner that, owing to the forces transmitted to the intermediate lever, a torque is always produced on the blocking part in the release direction thereof.

In various embodiments, when the lock latch is in the locking position, in particular main locking position and/or pre-locking position and the pawl is in the engagement position, the pawl is in supporting engagement via a supporting surface with the lock latch, and the force action line of the contact force between the lock latch and the pawl runs through the pawl pivot axis.

In various embodiments, the geometrical lock latch pivot axis of the lock latch and/or the geometrical intermediate lever pivot axis of the intermediate lever and/or the geometrical blocking lever pivot axis of the blocking lever are/is fixed with respect to the housing, wherein the geometrical pawl pivot axis of the pawl can be arranged on the intermediate lever and follows the movements thereof or is fixed with respect to the housing.

In various embodiments, the lock latch is pretensioned, in particular spring-pretensioned, in its opening direction and/or the pawl is pretensioned, in particular spring-pretensioned, counter to its disengagement direction and/or the intermediate lever is pretensioned, in particular spring-pretensioned, in particular via the pawl, in its basic position and/or the blocking part is pretensioned, in particular spring-pretensioned, in its blocking direction, wherein one and the same spring pretensions the pawl and/or the intermediate lever and/or the blocking part, in particular via one and the same spring leg or via different spring legs of the spring.

In various embodiments, a drive arrangement, in particular motorized drive arrangement with an electric drive motor is provided, said drive arrangement being configured to drive the blocking part in its release direction and/or counter to its release direction.

In various embodiments, a blocking part drive shaft which transmits a rotational movement from the drive arrangement, in particular from the drive motor and with respect to which the blocking part is arranged for conjoint rotation and which runs coaxially with respect to the geometrical blocking part pivot axis extends from the blocking part along the geometrical blocking part pivot axis through a housing wall of the motor vehicle lock to the drive arrangement, wherein the housing wall can form a partition between a wet side and dry side of the motor vehicle lock.

### BRIEF DESCRIPTION OF THE DRAWINGS

Various aspects will be explained in more detail below with reference to a drawing which merely illustrates exemplary embodiments. In the drawing

FIG. 1 shows a motor vehicle with a motor vehicle lock arrangement which has a motor vehicle lock according to the proposal which is installed here in a motor vehicle door,

FIG. 2 shows an exploded illustration of the motor vehicle lock according to the proposal together with a drive arrangement,

FIG. 3 shows a schematic illustration of an exemplary embodiment of the motor vehicle lock according to the proposal during an opening process illustrated in the views a) to d), and

FIG. 4 shows a schematic illustration of a further exemplary embodiment of the motor vehicle lock according to the proposal during an opening operation illustrated in views a) to d).

### DETAILED DESCRIPTION

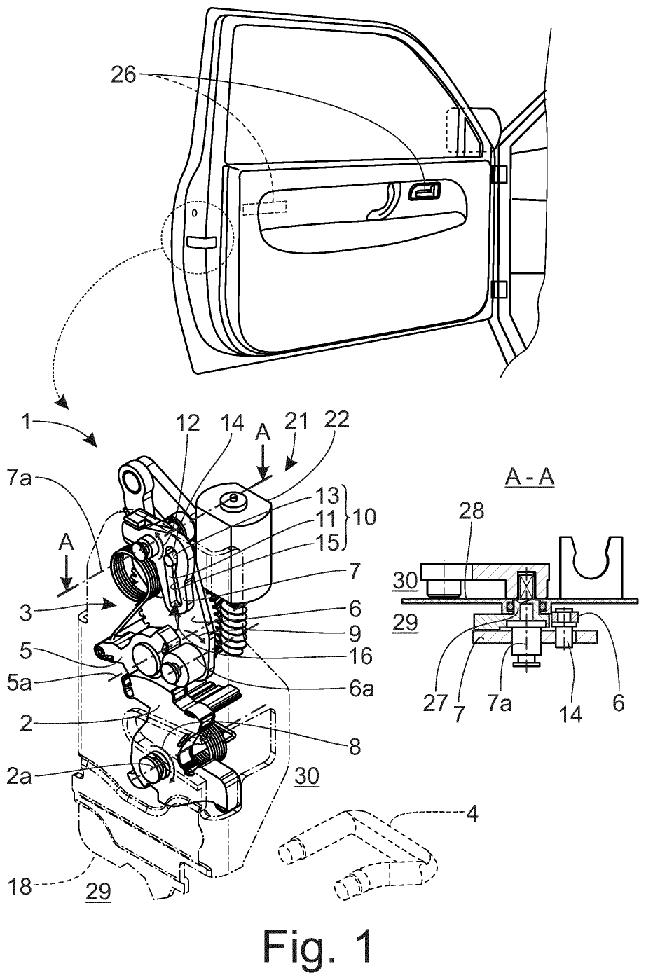

FIG. 1 illustrates by way of example a motor vehicle with an open motor vehicle door as a closure element. A motor vehicle lock arrangement is shown in enlarged form at the bottom of FIG. 1 in a perspective illustration and in a sectional illustration.

The motor vehicle lock arrangement has a motor vehicle lock 1 according to the proposal with a lock latch 2 and a pawl arrangement 3, wherein the lock latch 2 is pivotable into at least one locking position, in particular a main looking position and optionally a pre-locking position, in which it is in each case in holding engagement with a locking part 4, and an open position, in which it releases the locking part 4.

In various embodiments, the motor vehicle lock 1 is assigned to a closure element of the motor vehicle, here to the side door which is illustrated, whereas the locking part 4 is assigned to the body of the motor vehicle. In principle, however, the reverse case is also conceivable.

As discussed further above, the motor vehicle lock 1 according to the proposal and under discussion can be assigned to any closure element of a motor vehicle. This includes, in addition to side doors, also tailgates, trunk lids, front hoods, in particular engine hoods, or the like. All the statements made in this regard apply correspondingly to all other types of closure elements.

The pawl arrangement 3 has a pivotably mounted pawl 5 which interacts with the lock latch 2 and can be brought, in particular can be pivoted, into an engagement position and a disengagement position, a pivotably mounted intermediate lever 6 which interacts with the pawl 5 and can be brought, in particular can be pivoted, into a basic position and a deflection position, and a movably mounted blocking part 7, in particular a pivotably mounted blocking lever, which interacts with the intermediate lever 6, and can be brought, in particular can be pivoted, into a blocking position and a release position.

In some embodiments, of the three components “pawl 5”, “intermediate lever 6” and “blocking part 7”, the intermediate lever 6 and/or the blocking part 7 cannot be brought into contact with the lock latch 2 and/or only the pawl 5 can be brought into contact with the block latch 2. Additionally or alternatively, of the two components “intermediate lever 6” and “blocking part 7”, the blocking part 7 cannot be brought into contact with the pawl 5 and/or lock latch 2 and/or only the intermediate lever 6 is in contact or can be brought into contact with the pawl 5.

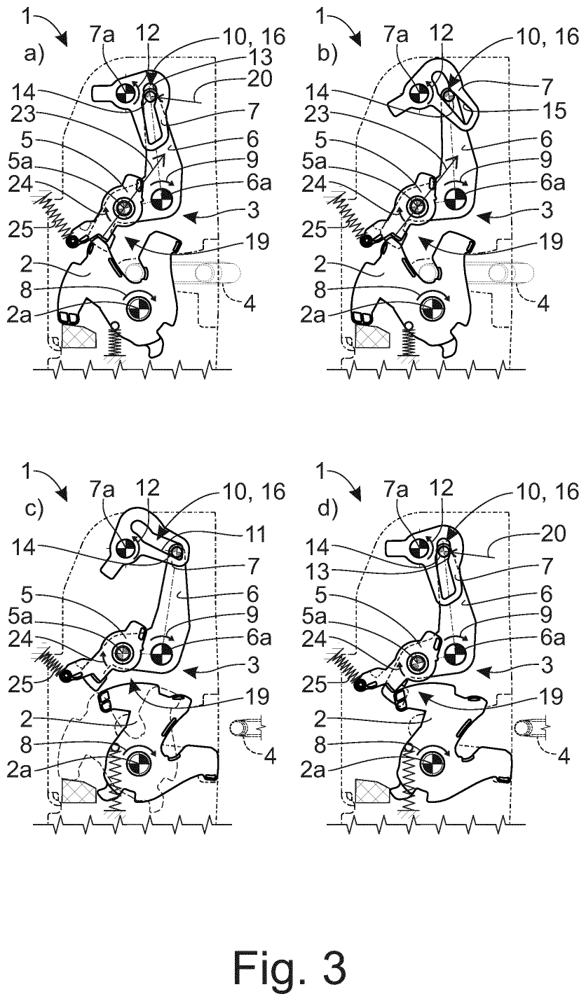

In a manner which is conventional per se, the engagement position (FIG. 3a), 4a)), the pawl 5 blocks the lock latch 2, which is in the respective locking position, against pivoting in its opening direction 8, that is to say in the direction from its locking position to its open position, and, in the disengagement position (FIG. 3c), 4c)), releases the lock latch 2 in its opening direction 8.

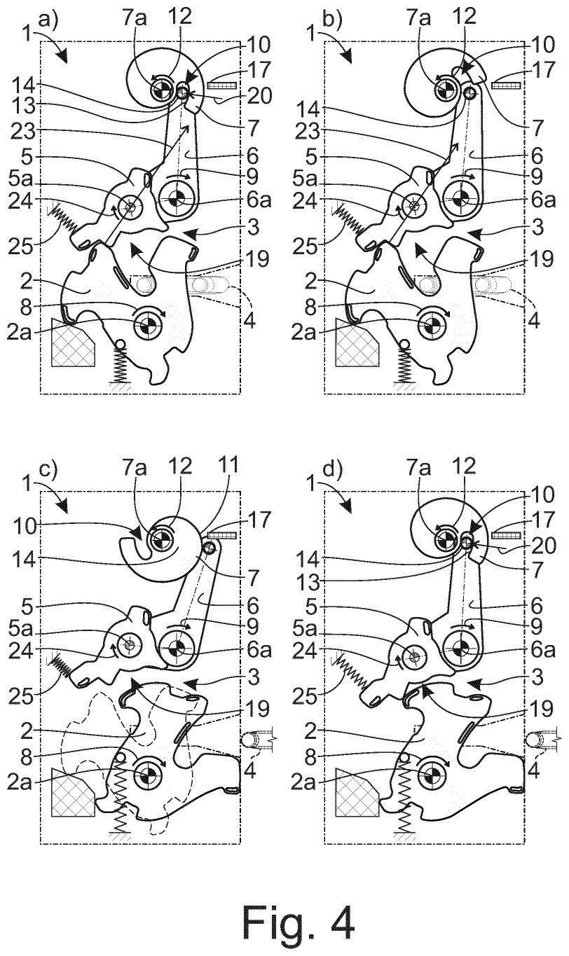

In the blocking position (FIGS. 3a) and d), FIGS. 4a) and d)), the blocking part 7, here the blocking lever, blocks the intermediate lever 6, which is in the basic position, against pivoting in its deflection direction 9, that is to say in the direction from its basic position to its deflection position, and, in the release position (FIGS. 3b), 4b)), releases the intermediate lever 6 in the deflection direction 9 thereof.

In the basic position of the intermediate lever 6, the pawl 5 is in its engagement position, in particular, if the lock latch 2 is in its locking position (FIGS. 3a), 4a)) or is pivotable into its engagement position, in particular by the lock latch 2 being brought from its open position into its locking position (FIGS. 3d), 4d)).

During the pivoting from its basic position into its deflection position, the intermediate lever 6 brings the pawl 5 into its disengagement position (FIGS. 3c), 4c)).

During the pivoting from its deflection position into its basic position, the intermediate lever 6 brings the pawl 5 into a position from which the pawl 5, when the lock latch 2 is brought from its open position into its locking position, pivots into its engagement position (FIGS. 3d), 4d)).

It is then essential that the blocking part 7, here the blocking lever, has a contour arrangement 10 with a pressing contour 11, and a force, in particular compressive force, can be exerted on the intermediate lever 6 by the blocking part 7 via its pressing contour 11 during the, in particular motor-driven, movement, in particular pivoting, of the blocking part 7 in its release direction 12, owing to which force a torque is produced on the intermediate lever 6 about its intermediate lever pivot axis 6a in the deflection direction 9 thereof. The release direction 12 here means the direction from the blocking position of the blocking part 7 to its release position.

A substantial advantage of this arrangement is that two functions can be realized with one and the same blocking part 7 and/or with one and the same contour arrangement 10, namely, firstly, a blocking function and, secondly, a break-away or icebreaker function. Thus, firstly, the intermediate lever 6 can be blocked via the contour arrangement 10 against pivoting in its deflection direction 9. Secondly, however, the same contour arrangement 10 can also be used to force the intermediate lever 6 in its deflection direction 9 if said intermediate lever is no longer blocked by the blocking part 7, in particular if the intermediate lever 6 is jammed, for example due to icing.

In order then to provide the blocking, i.e. the blocking function, the contour arrangement 10 can have a blocking contour 13 via which, in the blocking position, the intermediate lever 6, which is in the basic position, is blocked against pivoting in the deflection direction 9 thereof. This is illustrated schematically in FIGS. 3a) and 4a) for the two exemplary embodiments. A holding force is therefore exerted on the intermediate lever 6 by the blocking part 7 via the blocking contour 13. In some embodiments, the pressing contour 11 and the blocking contour 13 are spaced apart from each other and in particular face each other.

From this state which is shown in FIGS. 3a) and 4a), namely the locking state of the motor vehicle lock 1 according to the proposal, the motor vehicle lock 1 is opened. This is illustrated schematically for the first exemplary embodiment in FIGS. 3b) to d) and for the second exemplary embodiment in FIGS. 4b) to d).

In the locking state of the motor vehicle lock 1, the lock latch 2 is in its locking position and the pawl 5 is in its engagement position, that is to say, the lock latch 2 is blocked in its opening direction 8. In some embodiments, the lock latch 2 is not in contact with the intermediate lever 6. The intermediate lever 6 here is in its basic position and the blocking part 7 is in its blocking position.

In order to open the motor vehicle lock 1, then, as FIGS. 3b) and 4b) show, the blocking part 7 is moved from its blocking position into its release position, here is pivoted counterclockwise in relation to the blocking position. In some embodiments, the intermediate lever 6 here can be still in its basic position or is deflected somewhat from the basic position in the direction of its deflection position. The intermediate lever 6 is deflected here and in the further course of the opening operation for example by a pivoting movement directed in the clockwise direction. In the state shown in FIGS. 3b) and 4b), the pawl 5 is pivoted somewhat in relation to the engagement position shown in FIGS. 3a) and 4a), here counterclockwise, with the pawl 5, however, still being engaged and the lock latch 2 still being correspondingly blocked. The pawl 5 has moved here from a position in which it did not abut against the intermediate lever 6, into a position in which it now abuts against the intermediate lever 6.

It is illustrated in FIGS. 3c) and 4c) that the intermediate lever 6 has moved further, here in the clockwise direction, as far as its deflection position. This can take place by the forces which are exerted on the intermediate lever 6 by the lock latch 2 via the pawl 5 and/or by a rotational movement, here counterclockwise, of the blocking part 7, which, for example, is motor-driven. By means of the movement of the intermediate lever 6 into its deflection position, the pawl 5 is brought into its disengagement position. It is then still in abutment against the intermediate lever 6, but, by means of the deflection of the intermediate lever 6, is disengaged and therefore releases the lock latch 2. The pawl 5 is therefore not moved in relation to the state in FIGS. 3b) and 4b) relative to the intermediate lever 6. The blocking part 7 has moved out here, in particular in a motor-driven manner, beyond the release position in FIGS. 3b) and 4b), namely into the end position. This can be a final position of the blocking part 7. The lock latch 2 is pivoted here owing to a pretension acting thereon about the geometrical lock latch pivot axis 2a in relation to the locking position, here in the clockwise direction. The locking part 4 is then no longer in holding engagement with the lock latch 2.

FIGS. 3d) and 4d) finally show the end state in which the blocking part 7 has been moved back again into its blocking position and the intermediate lever 6 into its basic position. The lock latch 2 continues to be in its open position here. The pawl 5 continues to be disengaged, but now no longer butts against the intermediate lever 6, but rather is deflected relative to the intermediate lever 6, in particular is deflected even further than in its disengagement position and in particular is also deflected further than in its engagement position. The pawl 5 has pivoted here relative to the intermediate lever 6 in relation to the state in FIGS. 3c) and 4c), here in the clockwise direction, specifically in particular beyond the position shown in FIGS. 3a) and 4a) relative to the intermediate lever 6. The pawl 5 now lies here against the lock latch 2, which is in the open position. If the lock latch 2 is then pivoted about its geometrical lock latch pivot axis 2a, the pawl 5 engages again, here counterclockwise, in the respective engagement position until the state in FIGS. 3a) and 4a) has been reached again. The blocking part 7 and the intermediate lever 6 do not move during the engagement of the pawl 5 which first of all engages here in the pre-locking position and subsequently in the main locking position.

In some embodiments, a guide piece 14, such as a protrusion, in particular cam, of the intermediate lever 6 can be guided along the pressing contour 11 (during the movement of the blocking part 7 in its release direction 12) and/or along the blocking contour 13 (during the movement of the blocking part 7 from its release position into its blocking position). In some embodiments, this is a common guide piece 14 which can be guided along the pressing contour 11 and along the blocking contour 13.

When the guide piece 14 is guided along the pressing contour 11, a force is exerted on the intermediate lever 6 by the blocking part 7, owing to which force the torque is produced on the intermediate lever 6 in the deflection direction 9 thereof. When the guide piece 14 is guided along the blocking contour 13, the holding force is produced which blocks the intermediate lever 6 against pivoting in the deflection direction 9 thereof.

Furthermore, provision can be made that the respective force, owing to which the torque is produced on the intermediate lever 6 in the deflection direction 9 thereof, can be exerted on the intermediate lever 6 by the blocking part 7 already during the, in particular motor-driven, movement of the blocking part 7 from the blocking position into the release position. However, here the force can be exerted on the intermediate lever 6 by the blocking part 7 only during the movement of the blocking part 7 from its release position into its end position. It is also conceivable that the force can be exerted over the entire movement of the blocking part 7.

In the exemplary embodiment in FIG. 3, the contour arrangement 10 of the blocking part 7 can have a guide contour 15. After the blocking part 7 has passed from its blocking position into its release position, the intermediate lever 6, in particular a guide piece 14 or the guide piece 14 of the intermediate lever 6, can be braked via said guide contour 15 as the intermediate lever pivots from its basic position into its deflection position.

This can be the case if there is no jamming of the intermediate lever 6, for example due to icing, and the lock latch 2 exerts a force, resulting from the door sealing counterpressure and in particular a pretension, in particular spring pretension, on the intermediate lever 6 via the engaged pawl 5, from which force a torque results in the deflection direction 9 of the intermediate lever 6 about its intermediate lever pivot axis 6a. In this case, pivoting of the intermediate lever 6 in its deflection direction 9 is braked. Via the blocking part 7, a braking force therefore counteracts the movement of the intermediate lever 6. In particular, a force is then not exerted on the intermediate lever 6 by the blocking part 7 via its pressing contour 11.

According to FIG. 3, in various embodiments, the guide contour 15 and the pressing contour 11 can be spaced apart from each other and in particular face each other. Additionally or alternatively, as here, the guide contour 15 adjoins the blocking contour 13.

In principle, however, as illustrated in FIG. 4, an alternative embodiment of the blocking part 7 is also conceivable. In the exemplary embodiment of FIG. 4, the intermediate lever 6 cannot be braked by the blocking part 7 as the intermediate lever pivots from its basic position into its deflecting position after the blocking part 7 has passed from its blocking position into its release position. The blocking part 7 does not have a separate guide contour here.

In the exemplary embodiment in FIG. 3, the contour arrangement 10 of the blocking part 7 has a closed guide slot 16 which forms the pressing contour 11 and the blocking contour 13, in particular also the guide contour 15. Such a guide slot 16 brings about a high degree of dimensional stability within the blocking part 7, in particular in the event of a crash. Additionally or alternatively, as in FIG. 4, a stop part 17 which is fixed with respect to the housing and can counteract deformations of the blocking part 7, in particular in the event of a crash, can be provided. “Fixed with respect to the housing” means here the rigid arrangement on the lock housing.

In some embodiments, provision is furthermore made that the intermediate lever 6 forms a toggle lever mechanism 19 together with the pawl 5. Such a mechanism, in which the pawl 5 is mounted pivotably on the intermediate lever 6, makes it possible in a simple manner to hold the pawl 5 stably in its engagement position when the intermediate lever 6 is in the basic position, and to release said stable position in a simple manner, in particular with little effort, by the blocking part 7 deflecting the intermediate lever 6. A simple release of the pawl 5 from its engagement position and movement into its disengagement position is also promoted here by the fact that the lever arm of the intermediate lever 6 between its contact surface for engagement with the blocking contour 13 and the intermediate lever pivot axis 6a is longer than the lever arm between the pawl pivot axis 5a and the intermediate lever pivot axis 6a.

As FIGS. 3a) and 4a) show, in some embodiments, when the intermediate lever 6 is in the basic position and the blocking part 7 in the blocking position, the blocking part 7 is in supporting engagement via a supporting surface, in particular via the blocking contour 13, with the intermediate lever 6, in particular via the guide piece 14, and the force action line 20 of the contact force runs through the blocking part pivot axis 7a between the intermediate lever 6 and the blocking part 7.

That is to say that the blocking part 7 is driven by the intermediate lever 6 via said supporting engagement neither in the direction opposed to the release direction 12 nor in its release direction 12. In this specific configuration, the above supporting engagement between the intermediate lever 6 and the blocking part 7 is also referred to as “neutral engagement” or “engagement with neutral configuration” since the force action line 20 of the contact force between the intermediate lever 6 and the blocking part 7 runs through the blocking part pivot axis 7a such that no torque is produced on the blocking part 7 by the forces transmitted to the intermediate lever 6 by the lock latch 2 via the pawl 5. This can be achieved by a curved blocking contour 13 which runs concentrically about the blocking part pivot axis 7a.

However, it is likewise conceivable, according to another variant, that the force action line 20 of the contact force between the intermediate lever 6 and the blocking part 7 runs past the blocking part pivot axis 7a in such a manner that a torque is always produced on the blocking part 7 in a direction opposed to the release direction 12 because of the forces transmitted to the intermediate lever 6.

That is to say that the blocking part 7 is driven by the intermediate lever 6 via said supporting engagement in the blocking direction thereof. In this specific configuration, the above supporting engagement between the intermediate lever 6 and the blocking part 7 is also referred to as “engagement with locking tendency” or “engagement with undercut configuration” since the force action line 20 of the contact force between the intermediate lever 6 and the blocking part 7 runs past the blocking part pivot axis 7a in such a manner that a torque is always produced on the blocking part 7 in its blocking direction because of the forces transmitted to the intermediate lever 6 by the lock latch 2 via the pawl 5. Provision can in principle be made here that the force action line 20 runs within or outside the friction cone of the two friction partners “intermediate lever” 6 and “blocking part 7” when the intermediate lever 6 is in the basic position and the blocking part 7 is in the blocking position.

Also conceivable in principle is a variant in which the force action line 20 of the contact force between the intermediate lever 6 and the blocking part 7 runs past the blocking part pivot axis 7a in such a manner that a torque is always produced on the blocking part 7 in the release direction 12 thereof owing to the forces transmitted to the intermediate lever 6.

That is to say that the blocking part 7 is driven by the intermediate lever 6 via said supporting engagement in the release direction 12 thereof. In this specific configuration, the above supporting engagement between the intermediate lever 6 and the blocking part 7 is also referred to as “engagement with opening tendency” or “engagement with overcut configuration” since the force action line 20 of the contact force between the intermediate lever 6 and the blocking part 7 runs past the blocking part pivot axis 7a in such a manner that a torque is always produced on the blocking part 7 in the release direction 12 thereof owing to the forces transmitted to the intermediate lever 6 via the lock latch 2 via the pawl 5.

So that it is ensured in the last variant that, when the intermediate lever 6 is in the basic position and the blocking part 7 is in the blocking position, the blocking part 7 is not unintentionally shifted into the release position, for example during a journey over undulating ground or due to potholes, provision can be made as an additional measure that, when the intermediate lever 6 is in the basic position and the blocking part 7 is in the blocking position, the force action line 20 runs within the friction cone of the two friction partners “intermediate lever 6” and “blocking part 7”. Additionally or alternatively, provision can also be made that the blocking part 7 is pretensioned, in particular spring-pretensioned, in its blocking direction, specifically, in some embodiments, with a pretensioning force from which a torque is produced on the blocking part 7 in the blocking direction thereof, said torque being greater than or equal to the torque which is produced on the blocking part 7 in the release direction 12 thereof owing to the forces transmitted to the intermediate lever 6 by the lock latch 2 via the pawl 5. In the latter case, it is in principle even conceivable for the force action line 20 to run outside the friction cone of the two friction partners “intermediate lever 6” and “blocking part 7” when the intermediate lever 6 is in the basic position and the blocking part 7 is in the blocking position. Additionally or alternatively, provision can also be made that the blocking part 7 is held in the blocking position by a drive arrangement 21, in particular with an electric drive motor 22, via which the blocking part 7 is adjustable.

Furthermore, in some embodiments, as FIGS. 3a) and 4a) show, when the motor vehicle lock 1 is mounted, in particular is mounted in a motor vehicle door, provision is made that, when the lock latch 2 is in the locking position, in particular main locking position and/or pre-locking position, and the pawl 5 is in the engagement position, the pawl 5 is in supporting engagement via a supporting surface with the lock latch 2, and the force action line 23 of the contact force between the lock latch 2 and the pawl 5 runs through the pawl pivot axis 5a.

According to another variant which should likewise be mentioned for the sake of completeness, it is in principle also conceivable that the force action line 23 of the contact force between the lock latch 2 and the pawl 5 runs past the pawl pivot axis 5a in such a manner that a torque is always produced on the pawl 5 in the disengagement direction 24 thereof, i.e. in the direction away from its engagement position, owing to the forces transmitted to the lock latch 2 by the locking part 4. As a result, the pawl 5 is driven in the disengagement direction 24 by the lock latch 2 via said supporting engagement. In this specific configuration, the above supporting engagement between the lock latch 2 and the pawl 5 is also referred to as “engagement with opening tendency” or “engagement with overcut configuration”.

According to yet another variant, it is also conceivable that the force action line 23 of the contact force between the lock latch 2 and the pawl 5 runs past the pawl pivot axis 5a in such a manner that a torque is always produced on the pawl 5 counter to the disengagement direction 24 thereof owing to the forces transmitted to the lock latch 2 by the locking part 4. As a result, the pawl 5 is driven counter to the disengagement direction 24 by the lock latch 2 via said supporting engagement.

In the two last-mentioned variants, provision can also be made in principle that the force action line 23 runs within or outside the friction cone of the two friction partners “lock latch 2” and “pawl 5”.

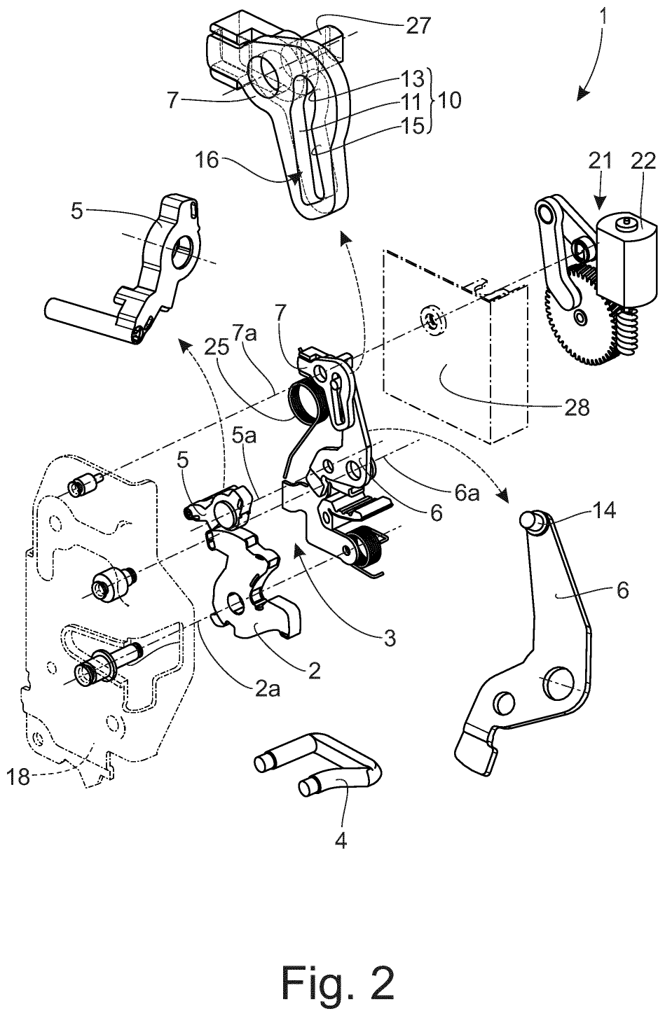

As in particular FIG. 2 shows, in some embodiments, the geometrical lock latch pivot axis 2a of the lock latch 2 and/or the geometrical intermediate lever pivot axis 6a of the intermediate lever 6 and/or the geometrical blocking lever pivot axis 7a of the blocking lever 7 is fixed with respect to the housing. “Fixed with respect to the housing” means here the rigid arrangement on the lock housing, for example locking plate 18. In some embodiments, the geometrical pawl pivot axis 5a of the pawl 5 is arranged on the intermediate lever 6 and follows the movements thereof. In principle, according to an embodiment which is not illustrated here, the pawl pivot axis 5a can also be fixed with respect to the housing.

In the exemplary embodiments which are illustrated, it is furthermore the case that the lock latch 2 is pretensioned, in particular spring-pretensioned, into its opening direction 8 and/or the pawl 5 is pretensioned, in particular spring-pretensioned, counter to its disengagement direction 24 and/or the intermediate lever 6 is pretensioned, in particular spring-pretensioned, in particular via the pawl 5, into its basic position and/or the blocking part 7 is pretensioned, in particular spring-pretensioned, in its blocking direction. In some embodiments, one and the same spring 25 pretensions the pawl 5 and/or the intermediate lever 6 and/or the blocking part 7. It is conceivable here that the spring 25 pretensions the respective components, in particular the pawl 5 and the intermediate lever 6, via one and the same spring leg of the spring 25. It is also conceivable that the spring 25 pretensions the respective components, in particular the pawl 5 and/or the intermediate lever 6, on the one hand, and the blocking part 7, on the other hand, via different spring legs of the spring 25.

It has already been mentioned previously that a drive arrangement 21, in particular a motorized drive arrangement 21 with an electric drive motor 22, can be provided in order to drive the blocking part 7. The drive arrangement 21 can be configured, as here, to drive the blocking part 7 in its release direction 12 and/or counter to its release direction 12. Additionally or alternatively, however, a manual actuation via a manually actuable actuating lever, in particular an actuating lever coupled to a door handle 26, for example door inside handle or door outside handle, is also conceivable.

FIG. 2 finally shows that, in some embodiments, a blocking part drive shaft 27 transmitting a rotational movement from the drive arrangement 21, in particular from the drive motor 22, and with respect to which the blocking part 7 is arranged for conjoint rotation and which runs coaxially with respect to the geometrical blocking part pivot axis 7a, extends from the blocking part 7 along the geometrical blocking part pivot axis 7a through a housing wall 28 of the motor vehicle lock 1 to the drive arrangement 21. In some embodiments, the housing wall 28 forms a partition between a wet side 29 and dry side 30 of the motor vehicle lock 1, also referred to as wet space/dry space separation. Such a passage of the drive train between the wet side 29 and dry side 30 can be sealed particularly simply. Just a rotating shaft 27 leads here through the housing wall 28 which can be sealed in a simple manner by means of an annular sealing element in the housing wall 28. In this way, the electric drive motor 22 and optionally present microswitches on the drive side 30 of the motor vehicle lock 1 are optimally protected against moisture.

1. A motor vehicle lock comprising a lock latch and a pawl arrangement, wherein the lock latch is pivotable into at least one locking position in which the lock latch is in holding engagement with a locking part, and into an open position, in which the lock latch releases the locking part, wherein the pawl arrangement comprises a pivotably mounted pawl which interacts with the lock latch and is configured to be brought into an engagement position and a disengagement position, a pivotably mounted intermediate lever which interacts with the pawl and is configured to be brought into a basic position and a deflection position, and a movably mounted blocking part interacting with the intermediate lever which can be brought into a locking position and a release position,
wherein, in the engagement position, the pawl locks the lock latch, which is in the respective locking position, against pivoting in its opening direction, and, in the disengagement position, releases the lock latch into its opening direction, wherein, in the locking position, the blocking part blocks the intermediate lever, which is in the basic position, against pivoting in the deflection direction thereof, and, in the release position, releases the intermediate lever in the deflection direction thereof,
wherein, in the basic position of the intermediate lever, the pawl is in its engagement position or is pivotable into its engagement position, and wherein the intermediate lever upon pivoting from its basic position into its deflection position brings the pawl into its disengagement position,
wherein the blocking part comprises a contour arrangement with a pressing contour, and in that during the movement of the blocking part in its release direction, a force can be exerted by the blocking part via its pressing contour on the intermediate lever, owing to which a torque is produced on the intermediate lever about its intermediate lever pivot axis in the deflection direction thereof.

2. The motor vehicle lock as claimed in claim 1, wherein the contour arrangement of the blocking part has a blocking contour via which, in the blocking position, the intermediate lever, which is in the basic position, is blocked against pivoting in the deflection direction.

3. The motor vehicle lock as claimed in claim 1, wherein a guide piece of the intermediate lever is configured to be guided along the pressing contour and/or along the blocking contour.

4. The motor vehicle lock as claimed in claim 1 wherein the respective force, owing to which the torque is produced on the intermediate lever in the deflection direction thereof, can be exerted on the intermediate lever by the blocking part during the movement of the blocking part from the blocking position into the release position and/or from the release position into an end position.

5. The motor vehicle lock as claimed in claim 1, wherein the contour arrangement of the blocking part comprises a guide contour via which the intermediate lever can be braked during the pivoting from its basic position into its deflection position after the blocking part has passed from its blocking position into its release position, or
wherein the intermediate lever cannot be braked by the blocking part during the pivoting from its basic position into its deflection position after the blocking part has passed from its blocking position into its release position.

6. The motor vehicle lock as claimed in claim 2, wherein the contour arrangement of the blocking part has a closed guide slot which forms the pressing contour and the blocking contour.

7. The motor vehicle lock as claimed in claim 1, wherein the intermediate lever forms a toggle lever mechanism together with the pawl.

8. The motor vehicle lock as claimed in claim 1, wherein when the intermediate lever is in the basic position and the blocking part is in the blocking position, the blocking part is in supporting engagement via a supporting surface, in particular via the blocking contour, with the intermediate lever and the force action line of the contact force between the intermediate lever and the blocking part runs through the blocking part pivot axis.

9. The motor vehicle lock as claimed in claim 1, wherein when the intermediate lever is in the basic position and the blocking part is in the blocking position, the blocking part is in supporting engagement via a supporting surface with the intermediate lever and the force action line of the contact force between the intermediate lever and the blocking part runs past the blocking part pivot axis in such a manner that, owing to the forces transmitted to the intermediate lever, a torque is always produced on the blocking part in a direction opposite to the release direction.

10. The motor vehicle lock as claimed in claim 1, wherein when the intermediate lever is in the basic position and the blocking part is in the blocking position, the blocking part is in supporting engagement via a supporting surface with the intermediate lever and the force action line of the contact force between the intermediate lever and the blocking part runs past the blocking part pivot axis in such a manner that, owing to the forces transmitted to the intermediate lever, a torque is always produced on the blocking part in the release direction thereof.

11. The motor vehicle lock as claimed in claim 1, wherein when the lock latch is in the locking position and the pawl is in the engagement position, the pawl is in supporting engagement via a supporting surface with the lock latch, and the force action line of the contact force between the lock latch and the pawl runs through the pawl pivot axis.

12. The motor vehicle lock as claimed in claim 1, wherein the geometrical lock latch pivot axis of the lock latch and/or the geometrical intermediate lever pivot axis of the intermediate lever and/or the geometrical blocking lever pivot axis of the blocking lever are/is fixed with respect to the housing.

13. The motor vehicle lock as claimed in claim 1, wherein the lock latch is pretensioned in its opening direction and/or the pawl is pretensioned counter to its disengagement direction and/or the intermediate lever is pretensioned in its basic position and/or the blocking part is pretensioned in its blocking direction.

14. The motor vehicle lock as claimed in claim 1 wherein a drive arrangement is provided, said drive arrangement being configured to drive the blocking part in its release direction and/or counter to its release direction.

15. The motor vehicle lock as claimed in claim 14, wherein a blocking part drive shaft which transmits a rotational movement from the drive arrangement and with respect to which the blocking part is arranged for conjoint rotation and which runs coaxially with respect to the geometrical blocking part pivot axis extends from the blocking part along the geometrical blocking part pivot axis through a housing wall of the motor vehicle lock to the drive arrangement.

16. The motor vehicle lock as claimed in claim 2, wherein the pressing contour and the blocking contour are spaced apart from each other and face each other.

17. The motor vehicle lock as claimed in claim 3, wherein a common guide piece is configured to be guided along the pressing contour and along the blocking contour. Page 9

18. The motor vehicle lock as claimed in claim 5, wherein the guide contour and the pressing contour are spaced apart from each other and face each other and/or the guide contour adjoins the blocking contour.

19. The motor vehicle lock as claimed in claim 12, wherein the geometrical pawl pivot axis of the pawl is arranged on the intermediate lever and follows the movements thereof or is fixed with respect to the housing.

20. The motor vehicle lock as claimed in claim 13, wherein one and the same spring pretensions the pawl and/or the intermediate lever and/or the blocking part.
